(19) United States
(12) Patent Application Publication
(10) Pub. No.: US 2024/0265899 A1
(43) Pub. Date: Aug. 8, 2024

(54) Systems and Methods for Combining Audio Samples

(71) Applicant: Georgia Tech Research Corporation, Atlanta, GA (US)

(72) Inventors: Gil Weinberg, Atlanta, GA (US); Hardik Gowel, Atlanta, GA (US); Nitin Ravindra Hugar, Atlanta, GA (US); Qinying Lei, Atlanta, GA (US); Thomas Ottolin, Atlanta, GA (US); Raghavasimhan Sankaranarayanan, Atlanta, GA (US)

(21) Appl. No.: 18/436,989

(22) Filed: Feb. 8, 2024

Related U.S. Application Data
(60) Provisional application No. 63/483,880, filed on Feb. 8, 2023.

(51) Int. Cl. G10H 1/00

(52) U.S. Cl. CPC G10H 1/0025; G10H 2210/145; G10H 2210/151; G10H 2220/126

(57) ABSTRACT

A first computer implements an audio mash-up computer program with a remote computer providing back-end operations via a data communications network. A graphical user interface on the first computer runs an audio mash-up computer program that provides digital content on the graphical user interface for identifying a plurality of respective audio sources of audio segments to combine into an output audio file. The graphical user interface is configured for displaying the respective audio sources as representative blocks of source data and allows a user to engage in arranging the representative blocks into lanes of respective audio tracks displayed on the graphical user interface. By combining the respective audio tracks into the output audio file according to an arrangement of the representative blocks as displayed in the lanes of respective audio tracks, the output audio file is configured for playing the respective audio tracks according to the arrangement.

### REFERENCE TO RELATED APPLICATIONS

This application claims priority to and incorporates by reference Provisional Patent Application Ser. No. 63/483,880 filed on Feb. 8, 2023, entitled “Systems and Methods for Combining Audio Samples.”

### BACKGROUND OF THE DISCLOSURE

Professional musicians have traditionally used applications such as Protools™, Ableton Live™, and Apple Logic Pro™ [9] to create mash-ups. Such Digital Audio Workstations (DAWs) often provide users with analysis tools, such as beat and key detection, as well as processing tools, such as automatic tempo and transposition manipulation. However, these applications require users to have significant experience with waveform editing through a sophisticated graphical user interface (GUI) of menus and editing windows. The process of creating high quality audio mixes, referred to herein as “mash-ups,” using these professional applications tends to be lengthy, and the outcome is fully dependent on the technical skills and musical talent of the users.

Over the last decade or two, researchers have tried to address the difficulties of forming mash-ups by developing computer applications, also referred to herein as “apps,” for novices that are designed to make the mash-up process easier and more intuitive. Some of these computer programs, such as AutoMash-upper™ [1] and PopMash™ [12], provide users with a “mashability” index by analyzing input songs and providing suggestions for songs that fit well together in terms of key, harmony, tempo and even lyrics. While this approach can simplify the mash-up process for novices, such applications either still rely on a sophisticated non-intuitive process, as AutoMash-upper™ does, or conversely, they completely automate the mash-up process and hardly offer meaningful or creative user input, as PopMash™ does. Earlier systems such as Massh!™ [11], for example, allowed users to collect and mash-up loops but did not supply commercial songs. These early systems also did not provide suggestions for song selection or any other creative input. Beat-Sync-Mash-Coder™ [4], for example, allows users to upload audio segments to a web interface. The system performs beat tracking, phase vocoding, and alignment to mash-up these clips together. Still, users are not given creative control over the structure of these mash-ups, nor a visual representation of their creation. One approach for visualization of mash-ups has been taken by MixMash™ [8], which provides a proximity map to assist users in choosing “mashable” audio segments based on harmonic compatibility and other metrics based in music theory and composition. This visualization, however, is not geared for the creation process, rather the identification of appropriates sources.

None of these noted works focuses on allowing users to “mash up” commercial songs of their liking or offering automatic support in converting compositional ideas into coherent songs of mixed tracks of audio data. This challenge was addressed by Harmonix™ commercial application DropMix™ [3]. This mixing game provides physical RFID cards representing commercial songs and allows users to mash them up together using gaming challenges. While supporting user engagement through the presentation of commercial songs, DropMix™ does not provide users with creative input in editing the songs and relies on a small number of pre-prepared songs that come with the game.

A need exists for an approach to creating mash-ups that gives the user the benefits of automated computer operations an simultaneously allowing for the individual to have creative input into the final output.

### SUMMARY OF THE DISCLOSURE

A system for combining audio tracks includes a first computer having a processor and computer memory storing front-end software implementing an audio mash-up computer program. A remote computer includes a remote processor and remote computer memory implementing back-end software corresponding to the audio mash-up computer program, wherein the computer and the remote computer communicate over a data communications network. A graphical user interface on the first computer that is configured with the processor and audio mash-up computer program executes steps providing digital content on the graphical user interface for identifying a plurality of selected audio files as respective audio sources of audio segments to combine into an output audio file. The graphical user interface is configured for displaying the respective audio sources as representative blocks of source data and allows a user to engage in arranging the representative blocks into lanes of respective audio tracks displayed on the graphical user interface. By combining the respective audio tracks into the output audio file according to an arrangement of the representative blocks as displayed in the lanes of respective audio tracks, the output audio file is configured for playing the respective audio tracks according to the arrangement.

This disclosure includes a computer implemented method of combining audio tracks having steps of using a computer to run an audio mash-up computer program utilizing computer implemented instructions that execute the steps with a processor and identifying a plurality of selected audio files as respective audio sources of audio segments to combine into an output audio file; displaying the respective audio sources as representative blocks of source data; arranging the representative blocks into lanes of respective audio tracks displayed on the graphical user interface; and combining the respective audio tracks into the output audio file according to an arrangement of the representative blocks as displayed in the lanes of respective audio tracks, wherein the output audio file is configured for playing the respective audio tracks according to the arrangement. These steps may be included, at least in part in a front-end software program running an audio mashup computer program.

All embodiments of this disclosure may be included in a computer program product stored on a non-transitory computer readable medium having computer implemented instructions that when executed by a processor execute a computerized method with steps including using a computer to run an audio mash-up computer program with computer implemented instructions that execute steps with a processor. The steps may include, without limitation, identifying a plurality of selected audio files as respective audio sources of audio segments to combine into an output audio file; displaying the respective audio sources as representative blocks of source data; arranging the representative blocks into lanes of respective audio tracks displayed on the graphical user interface; and combining the respective audio tracks into the output audio file according to an arrangement of the representative blocks as displayed in the lanes of respective audio tracks, wherein the output audio file is configured for playing the respective audio tracks according to the arrangement.

### BRIEF DESCRIPTION OF FIGURES

The components in the drawings are not necessarily to scale relative to each other. Like reference numerals designate corresponding parts throughout the several views.

FIG. 1 is a schematic view of a front-end software application displayed on a graphical user interface of a first computer to implement an audio mash-up computer program according to this disclosure.

FIG. 2 is a schematic view of a front-end software application displayed on a graphical user interface of a first computer to implement an audio mash-up computer program having options for assistance in creating the mash-up with artificial intelligence and previously created templates according to this disclosure.

FIG. 3 is a schematic view of a front-end software application displayed on a graphical user interface of a first computer to implement an audio mash-up computer program with a set of selected audio sources according to this disclosure.

FIG. 4 is a schematic representation of a method having steps for implementing an audio mash-up computer program according to this disclosure.

FIG. 5 is a schematic representation of a method having steps for implementing a back-end software program corresponding to the audio mash-up computer program of FIG. 4 according to this disclosure.

FIG. 6 is a plot of test results from user satisfaction tests for an audio mash-up system according to this disclosure.

FIG. 7 is a plot of test results from user satisfaction tests for an audio mash-up system according to this disclosure.

FIG. 8 is a plot of test results from user satisfaction tests for an audio mash-up system according to this disclosure.

FIG. 9 is a schematic representation of a computer environment in which the computers processing activities of this disclosure may operate to form an output audio file.

### DETAILED DESCRIPTION

Technical terms in this disclosure are intended to have their broadest plain meaning that the context allows. For example, the term “mash-up” is intended to have the broadest plain meaning related to combining all kinds of audio files with and without certain tracks or sections of audio data playing simultaneously, even if the audio files originate from entirely different sources. The term “tracks”, includes, without limitation, the individual component audio data of the mashup, including but not limited to the examples discussed below, including vocals, drums, bass, and chords. As used herein, the term “lanes” represents graphical sections for each track on the user's computer as discussed herein and shown in the figures. References to “blocks” refer to representative icons of sources of audio that can be placed within a mashup at a requested length in any given lane of audio tracks. Other terms are discussed in the context of a back-end software program processing audio sources divided into stems, which generally refers to stems, which are sections of the audio files, such as songs, and have a particular length or designation but including all layers of the source audio tracks (i.e., stems are recording sections of an audio file that can include numerous tracks therein, including but not limited to voice, bass, drums, and chords. Along those lines, as used herein and without limiting this disclosure, “segments” are individual components of respective tracks extracted from the stems. Accordingly, the “stems” can each be separated into “segments” that have one kind of track (e.g., vocal, bass, drums, or chords).

Through an overview of the industry, the work discussed below identified a “white space” area ready for development of a new audio mash-up creation application at the intersection between sophisticated professional applications and simplistic commercial applications for novices. One non-limiting goal is to improve user engagement with the new audio mash-up creation application by offering commercial songs as sources for a mash-up, providing an intuitive visual, canvas-like interface where users can visually organize and manipulate their favorite songs, and offering an effective balance between automation and user control that would surprise and inspire users while providing them with ownership and control over the final outcome.

An audio mash-up application according to this disclosure, commercially referred to as MixBoard™ in non-limiting contexts, is an audio mash-up computer program that allows music lovers to create and share personalized musical mash-ups. The application or “app” allows users to choose and organize icons representing any audio file, such as a song recording, into four different lanes that are visible on a computer from a graphical user interface of a computer, such as a personal computer, phone, tablet or the like. In non-limiting embodiments, the icons are graphical images that identify an audio source, such as, but not limited to, artwork taken from an album cover. The app and associated system automatically separate the sources of the songs into their corresponding stems, calculate an appropriate tempo and key for the mash-up, and choose song segments according to users' visual creation. Unlike other professional applications used for mash-ups, the audio mash-up computer program discussed herein, e.g., Mixboard™, does not require experience with Digital Audio Workstations (DAWs) or familiarity with waveform editing. On the other hand, it is not restricted to a set of pre-matched songs. These features are useful and different from mash-up applications that are designed for the general public. In a co-creative artificial intelligence (“AI”) fashion, users can explore their musical and visual creativity while the system of the computer application contributes its own creative input through Music Information Retrieval (MIR), Digital Signal Processing (DSP), composition rules and templates available in a template library. As discussed below, a set of user studies were conducted to evaluate the audio mash-up application's success in achieving an effective balance between system automation and user control. Results indicate strong metrics for user creative expression, engagement, and ownership, as well as high satisfaction with the final musical outcome. Results also suggest a number of modifications to the balance between user control and system automation.

The audio mash-up computer program of this disclosure is designed to allow novice musicians and music lovers to easily and intuitively create high quality mash-ups. The audio mash-up computer program is designed as a co-creative agent that contributes to the musical decision making, rather than a tool for the user to fully control. In addition to handling low level computational tasks such as source separation, segmentation, tempo and key detection, stretching, and transposition, the computer program and associated AI is also tasked with selecting musical segments and suggesting compositional structures. The goal of these higher-level artistic tasks is to inspire users to engage in creative activity in a manner that they would not be exposed to if they used the application as a fully controllable tool. Therefore, one non-limiting motivation behind developing an audio mash-up application and audio mash-up computer program is to achieve an effective balance between allowing users to explore their creativity while the artificial intelligence (AI) automates some of the tedious, musically demanding tasks. The computer program also provides musical ideas for the users to explore. This balance alludes to the desired symbiotic relationship between user and AI, when the user learns and benefits from the AI's output.

To address these goals, an audio mashup application and audio mash-up computer program, according to non-limiting examples in this disclosure, enable users to create audio mash-ups of up to four commercially available songs. User can select songs using a commercial audio file platform (e.g., Spotify™) search engine or retrieve the songs directly from a private library of previously purchased or public domain songs. In non-limiting embodiments, a backend system may utilize open-source MIR libraries to detect the songs' tempos and keys, separate the sources into stems and segment each stem accordingly. It also utilizes an implementation of the silence detection algorithm to filter out silent segments from the stems.

In non-limiting embodiments, users can then drag and drop icons representing the respective audio source files (e.g., album art of each selected song) into four (4) tracks: Vocals, Bass, Drums, and Chords. Chords may include of all the audio source tracks that were not separated to vocals, bass or drums. The system chooses the stem according to the lane of the track it is dragged into and segments this stem based on the user's visual creation on the canvas. Users can also choose to start their creative process by clicking a Lucky Me/Surprise Me button which offers pre-created templates to start the mash-up. In non-limiting embodiments, the templates can include suggestions for audio files to combine along with placement of certain designated portions of the audio files in the output mash-up product. Users can control and manipulate the segments length within 16-32 bars of music, representing a short mash-up and a long mash-up, respectively. This disclosure is not limited by examples discussing mash-up lengths or the number of audio sources that can be used in generating a mash-up. After generating the mash-up, users can play, download and share their creation.

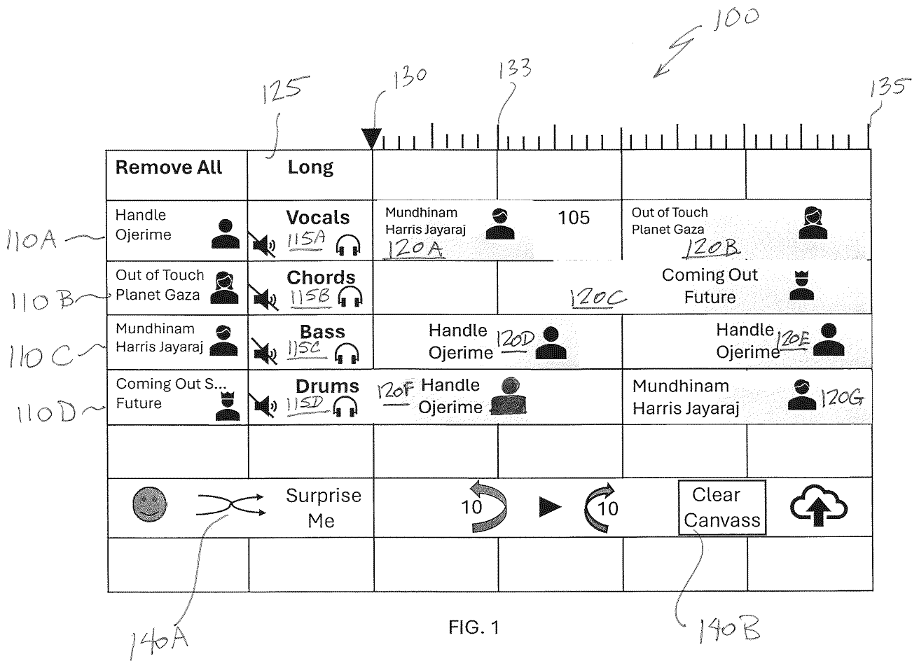

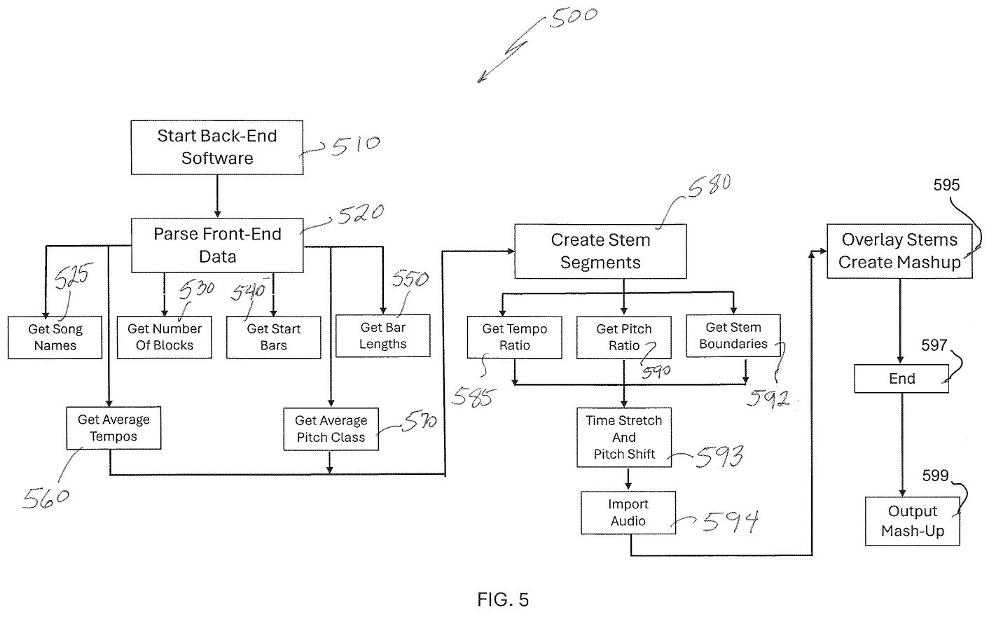

In non-limiting embodiments, the app includes a front-end user interface 100 and a backend server. This is just one arrangement for data processing, however, and the concepts of this disclosure may be practiced on a single computer, whether a mobile computer or a server as well. For the front-end, this disclosure implemented a web app, as well as an iOS app, and other operating systems are available as well (e.g., Android). One non-limiting embodiment uses HTTP requests to allow a first computer (e.g. a mobile computer or mobile telephone) to communicate with a backend computer, such as a server or a network of servers in the cloud. Users can choose a plurality of songs such as, but not limited to, four (4) songs from either a pre-processed library of songs or from commercial platforms (e.g., Spotify). They can then add any combination of these songs to any of the lanes (vocals 115A, chords/instruments 115B, bass 115C, and drums 115D) on the canvas 105. FIGS. 1-3 are shown as examples, and illustrates how a user can determine which of the audio sources 110A, 110B, 110C, 110D should be included in a final mash-up product, when the audio sources contribute tracks, and which tracks play simultaneously, illustrated by a vertical overlap of audio sources in the lanes 115A, 115B, 115C, 115D. The segments of an audio source to be used in a mash-up can be represented by icons showing the segments as representative blocks 120A, 120B, 120C, 120D, 120E, 120F, 120G, 120H of audio data on the canvas 105 that can be moved, lengthened, shortened, or deleted after users lay them on the canvas 105. Once users are happy with the layout, they can press a button to generate the mash-up. This sends an HTTP request with all front-end information about the songs or audio sources 110A, 110B, 110C, 110D and the user edits to the server for processing by a back-end computer program software as shown in FIG. 5. The system chooses the appropriate segments of each audio source (e.g., songs in this example) as well as the global tempo and key for the mash-up. When the mash-up is rendered, users can press the play button to listen to their creation.

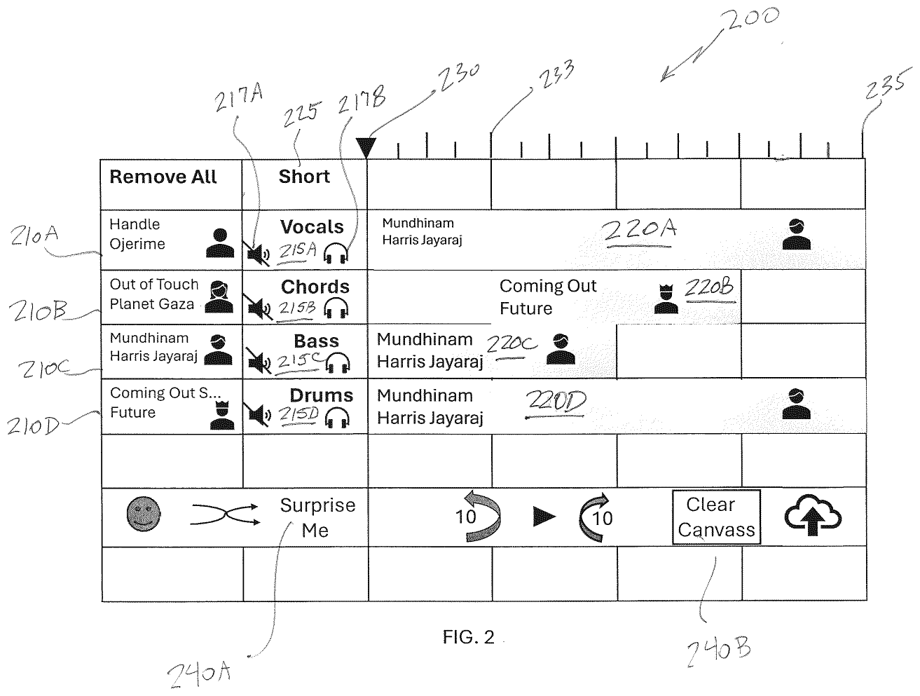

FIG. 2 illustrates similar aspects of a front-end graphical user interface 200 exhibiting a canvas 205 on which a user can create an arrangement of segments 220A, 220B, 220C, and 220D of audio sources 210A, 210B, 210C, 210D in lanes 215A, 215B, 215C, 215D. FIG. 2 highlights options in which a user can rely on a back-end computer program, which may be on a remote computer such as a server, to help a user by providing song choices and templates for placing the representative blocks 220A, 220B, 220C, 220D. Where FIG. 1 illustrated a long bar length option 125, FIG. 2 illustrates a short bar length option 225. The user can choose between the options, and in non-limiting examples, the short bar length option can be 16 bars long, and a long bar length option can be 32 bars long. Other lengths are optional in other non-limiting embodiments. If a user chooses to have the system provide assistance with audio source selection and placement of tracks, the graphical user interface 200 of FIG. 2 can include a “Surprise Me” or “Lucky Me” function 240A that is selectable through the graphical user interface. Any time a user wants to start over, the graphical user interface 200 includes a “clear” function 240B allowing the user to start over.

After preliminary experimentation with a “Contour Editing Tool” that allowed users to draw a curve of tension and release for the mash-up, this disclosure also includes a canvas-like “building block” metaphor for the interface. The first version was accessible via web browser. A second iOS version was later built for revising a few features and streamlining the interface. Other operating systems can also support the audio mash-up application described herein.

The web interface was designed using the Vue.js framework (https://vuejs.org). It features the album art of the selected songs to represent audio sources 110A, 110B, 110C, 110D and allowed users to drag and drop up to four songs from the left pane of the interface into a 4-lane “canvas” on the right as shown in FIGS. 1-3. Users can search for audio sources, such as, but not limited to songs by title or artist names. Users can also play a preview of the selected song and see whether a song is already downloaded to the system server, or whether it has to be downloaded. After choosing their desired songs, users can drag any song to any of the 4 lanes 115A, 115B, 115C, 115D, which may include, for example, “Vocals”, “Instruments” (“Chords” in some versions), “Bass”, and “Drums.” Without limiting the disclosure and only by example, the default segment length of each representative block 120A-120F was chosen to be 8 bars, which users could then adjust after placing it. This version of the app has a dedicated Generate button. A GET request is made to the server on pressing Generate. The front-end waits until the server sends the audio data back or the error code in case of failure. The app also displays the current generation progress while it waits.

To address one non-limiting goal of providing system-generated ideas, the interface allows users to press a “LuckyMe” button (also known as a “Surprise Me” in the iOS version), which randomly chooses from a set of prepared layouts. These layouts were created based on popular song structure guidelines and involved an element of stochastic song selection. Another simplifying feature that was added to help novices interact with the app is “Choose for Me,” where the system automatically selects the 4 songs to be used in the session.

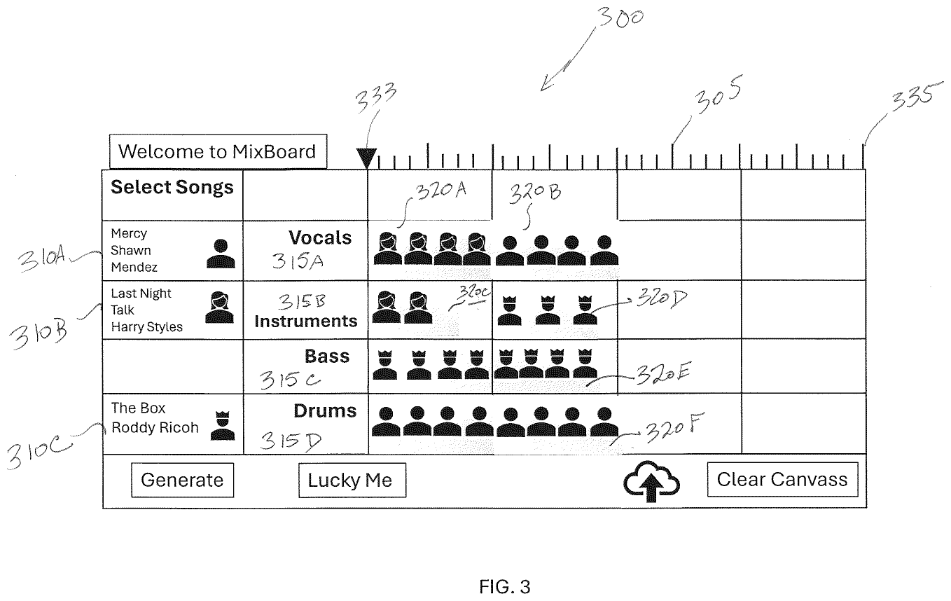

FIG. 3 illustrates an example of a user using a graphical user interface 300 of this disclosure to display a canvas 305 to implement an audio mash-up computer program according to this disclosure. In this example, the either the user or an AI assisted software has selected only three audio sources 310A, 310B, 310C for segmenting into tracks and placing the tracks in an arrangement according to lanes 315, which in non-limiting examples, includes a respective lane for vocal tracks, chord or instrumental tracks, bass tracks, and drum tracks. The user can set the overall bar length 335 for an output audio file that is a mashup of segments from the audio sources 310A, 310B, 310C played according to the arrangement shown in the graphical user interface. The arrangement displays segments of the audio sources as representative blocks, or icons, 320A, 320B, 320C, 320D, 320E, 320F that are configured to be moved to different positions within a lane horizontally or even across lanes vertically (for a different kind of track extraction) along the bar length 335, and the representative blocks are further configured to be shortened or stretched according to how many bars or beats the user wants to include from that audio source. In the example arrangement of FIG. 3, the user has designed a mash-up of segments from audio sources 310A, 310B, 310C in the lanes 315 with representative blocks 320A, 320B, 320C, 320D, 320E, 320F having lengths determined by a number of bars 333 within a total number of bars 335.

After generation, as users listen to their mash-up, the interface provides a “play head” cursor across the four lanes while also highlighting the segments the users are listening to in real-time. This feature attempts to create engaging, continuous listening, allowing users to anticipate the next sections of the song based on the upcoming album art. At the bottom of the interface, users can interact with a library of mash-ups, allowing them to return to their previous creations for further editing or listening. Users can also name and download their mash-ups.

Two features were added to the interface for testing the back-end functionality to improve the quality and coherency of the final mash-up output: “Lane Link” and “Section Sync”. These features were not intended to be user-controlled, rather they were added to garner research study feedback to inform how the system could more consistently generate pleasing mash-ups (RQ3).

Lane Link: When this feature is on, if the same song appears in multiple lanes at the same time, the system chooses the segments from the same location of the song to improve coherency.

Section Sync: When this feature is on, the placement of a segment within any lane would correlate generally to the corresponding placement of the segment in the original song. For example, a segment that occurs on the first measure would be chosen from the beginning of the original song.

In some embodiments, the lane mixing happens on the first computer instead (unlike the web app where the mixing happens in the back-end server). This enables the users to mute or preview lanes independently, if desired, as illustrated at FIG. 1, Refs. 217A, 217B. The search is split into two sections: a library for pre-processed songs already on a private server, and links to commercial audio file sources such as but not limited to Spotify for songs that needs to be downloaded. Song segments can overlap in a vertical direction up and down the canvas 105, 205, 305 to play certain tracks (vocals, bass, drums, chords) simultaneously or may overlap horizontally within a lane to create smoother transitions. Lastly, users are prompted to create an account and sync their commercial music streaming account; this serves as foundation for future features that can recommend music or display user playlists. By creating an account, user-created mash-up sessions are automatically saved on a database in the cloud, e.g., a Firestore database (https://firebase.google.com/) which they can recall anytime. In non-limiting embodiments, application development entities may host their own server to manage the song library and process client requests.

FIG. 5 shows the back-end workflow, which may occur in a back-end software program stored on a remote computer relative to a user's first computer (i.e., a user's mobile computer or smart phone). There are two ways to choose a song. One is to choose from the internal library and the other is to choose from a commercial platform, such as but not including Spotify™. The internal library has songs that are already pre-processed and ready to be used in the mash-up.

When the user chooses a song from a commercial platform, there are various pre-processing steps that are carried out before it can be used in the mash-up. The audio samples of the song are downloaded from an online connection to the internet (e.g., Youtube using the SpotDl library https://github.com/spotDL/spotify-downloader. In some non-limiting examples, the audio mash-up application uses the BeatNet™ [5] model to compute downbeats of the song. The back-end software also uses the offline non-causal mode that uses samples bidirectionally for the computation. In non-limiting embodiments, the back-end software of the system then separate the sources of the song using Demucs™ [2] into vocals, bass, and drum for their corresponding lanes and all other instruments in a fourth lane, optionally labeled chords. Each of these lanes are then passed through a silence detection algorithm that this work developed. This algorithm is run on every downbeat of all the tracks and filters out beats that are silent. For example, a dance break without vocals could be played within all lanes other than vocals. The final downbeat values are saved as part of the song metadata in JSON format.

The data from the front-end software running on a first computer, such as the songs selected, the position and length of each block, and the type of track (vocal, chords, bass, or drums), are communicated to the back-end using HTTP requests in the JSON format. Metadata such as tempo, key, and mode for each song is fetched from the stored metadata and used to calculate the optimal tempo, and pitch of the final mash-up.

Each of the four lanes of track types (Vocals, Chords, Bass and Drums) is created by generating every block in that lane individually and then putting them together at the position as defined by the user. Given the length of the block in bars, a corresponding length of audio is chosen from the song's stem. This block of audio is time-stretched, and pitch-shifted to the optimal tempo and pitch using Elastique-Pro™ [13]. If no non-silent block of the required length is present, a block of smaller length is selected and looped to fit the required length. The lanes' audio samples are mixed together after all the segments are generated.

The optimal tempo may be optionally calculated as the mean of the tempos of the selected songs. But if the tempo of one song is far greater or smaller than the rest of the songs, this would significantly skew the tempo of the mash-up. In such a situation, the tempo of that particular song is either halved, doubled, or otherwise adjusted in order to bring the value closer to the tempos of the other songs. This calculation algorithm was evaluated specifically within the listening test in Study 2, which is discussed below.

In order to calculate optimal pitch, the modes of all the selected songs are considered to be minor or major by converting the songs to either the relative minor or relative major. Converting to either major or minor is decided by prioritizing a minimal difference in the original key and the final key for each song. The pitches are then averaged to get the optimal pitch. This calculation algorithm was also evaluated specifically within the listening test in Study 2, discussed below.

### Example Evaluations

This disclosure conducted two separate studies to evaluate the web interface example embodiment, each addressing a different set of research questions. Forty-five subjects between 18-27 years were recruited for the studies. Recruitment for both studies excluded those with more than a year of music mixing or composition experience. The screen and audio of the system, as well as the participant's questions and comments were recorded during each study. A click counter algorithm was implemented to learn about participants' behavioral preferences. Participants were given up to 30 minutes to interact with the system.

The users either self-elected to end the experimentation or were intervened at the 31st minute to transition to the next part of the study. Participants were encouraged to share their observations and questions aloud, however questions regarding system mechanics or feature requests were tabled for the end of the study. After the experimentation period ended, this work conducted a semi-structured interview. After the interview, participants completed a 20 question survey using a 5-point Likert scale [6]. The first seven questions evaluate the measures created by Louie et al [7]. These measures were chosen as they were designed to assess co-creativity with a musical AI system:
Creative expression: “I was able to express my creative goals in the composition(s) made using this system.”;
Engaging: “Using this system felt engaging.”;
Learning: “After using this system, I learned more about music composition.”;
Uniqueness: “The composition(s) I created using this system feels unique.”;
Ownership: “I felt that the composition(s) created was my own work.”;
Completeness: “The composition(s) I created using this system feels complete.”,
Trust: “I would use the system again.”

These measures were applicable to the audio mash-up application and the associated research questions, but this study included three more measures to capture more specified feedback for Research Question 1 (RQ1), Research Question 2 (RQ2), and Research Question 3 (RQ3):
Control: “I felt I had proper control over the composition(s) created.”;
Automation: “The system should automate more of the composition process for me.”,
Speed: “I felt that the system should operate faster.”.

The Engaging, Trust, and Speed measures were chosen to assess RQ1. The Creative expression, Learning, Uniqueness, Ownership, Control, and Automation measure were chosen to inform RQ2. The Completeness measure, listening test preferences, and interview questions applied to RQ3. The final ten Standard Usability Scale questions focused on assessing RQ1. Survey data was aggregated to generalize findings quantitatively by assessing the measures of central tendency of each study group. Observational notes, questions, and comments were qualitatively coded in order to conduct a thematic analysis on the most common requests, confusions, and complaints.

Study 1 involved 13 male and 12 female participants and was aimed to investigate RQ1 and RQ2, focusing on evaluating user experience and balance between automation and control. In order to test the system usability and intuitiveness, this work designed a between-subjects mixed study, where one group received a system tutorial before beginning the experiment, and the other group did not; receiving a tutorial was the only difference between the two groups.

Study 2 explored RQ3 through testing a variety of features designed to improve the quality of the musical outcome. It involved 11 male and 9 female participants. For this study, all participants were provided with a tutorial of the system, which included explanation of the Lane Link and Section Sync features. After following the same protocol as Study 1, subjects took a listening test, where they were asked to listen to 3 pairs of system-generated mash-ups. The first two pairs featured the same four songs placed identically within the canvas.

The first pair featured a mash-up with Lane Link turned on and one with this feature turned off. The second pair featured a mash-up with Section Sync turned on and off accordingly. The third pair consisted of a set of four songs that were different from the ones used in the previous tests. They compared two algorithmic approaches for determining the key and tempo of a mash-up. The study aimed to evaluate whether the tracks in vocals should receive a greater weight in determining the key and tempo, or if each track should be equally evaluated to determine these attributes. This study included 8 interview questions.

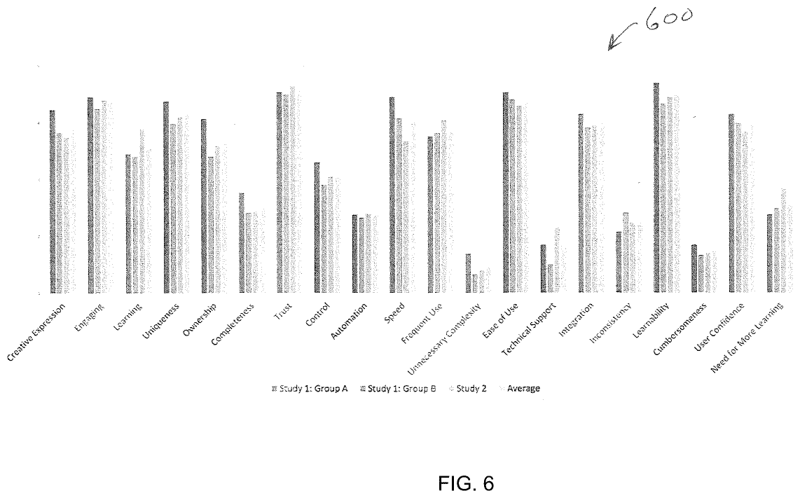

Results from the 20 Likert-scale measures are shown in FIG. 6. This work found that the audio mash-up application can be evaluated to be:
significantly engaging (mean (u)=4.4;
standard deviation ( )=0.86);
trustworthy (u=4.6, q=0.65);
easy to learn (u=4.5, @=0.78);
not unnecessarily complex (u=1.4, @=0.58); and
not overly cumbersome (u=1.7, @=0.88).

Users from Group B who went through the tutorial did not show a significant impact for any of evaluated measures. On average, Group B participants spent less time editing any particular mash-up (Xbar=4.6 minutes) than Group A (Xbar=5.5 minutes). Additionally, Group B participants generated more compositions (Xbar=15 mash-ups) than Group A (Xbar=11 mash-ups). These findings indicate that the interface was intuitive and did not require a tutorial to provide improved results. The high number of total mash-ups paired with the lower editing times also demonstrate how engaging the experience was, and how exploitative the participants were in interacting with the system. Of the 17 participants in Study 2 who were questioned about pitch and tempo calculations, 13 participants preferred the algorithm that more heavily weighted the vocal tracks' pitches and tempos. 11 preferred the mash-up with Section Sync turned on, and 12 preferred the mash-up with Lane Link turned on. Additionally, the inclusion of Lane Link and Section Sync may have made the system less intuitive, noted by the increased scores for the learning, technical support, and need for more learning measures, seen in Table 5. These findings informed how the algorithms should be developed, addressing RQ3.

TABLE 1
Averaged Measures Across Studies

| Measure | Study 1A | Study 1B | Study 2 |
|---|---|---|---|
| Learning | 3.5 | 3.4 | 3.9 |
| Technical Support | 1.8 | 1.5 | 2.2 |
| Need for More Learning | 2.4 | 2.5 | 2.9 |

RQ1 focused on investigating the system's usability. Since only 5 participants clicked on the tutorial button during the studies and only 4 opted to end the session before full 30 minutes, these works conclude that in general the interaction was enjoyable and engaging.

Some participants began by placing one segment onto one track and immediately generating; those who did so tended to build lane-by-lane, which bears similarity to the findings Louie et al. put forward on their system Cococo[7]. Other participants used Luckyme, but there were no participants who exclusively relied on the Luckyme feature during the experiment. While Mixboard, the audio mash-up application of this disclosure, was not designed for educational goals, some participants felt they have gained new knowledge about music through interaction with the application.

One of the participant said, “Before this, I thought bass was just a big beat drop, but after playing with this, I didn't really know how to distinguish between bass and drum. I thought it was the same, but I guess it isn't” (P43). Another participant shared, “I didn't really have anything in mind that I wanted to create, but I did accomplish experimenting with different sounds . . . I learned a lot from it” (P30). This commentary, supported by the high score in the Learnability measure, shows how the AI sparks creativity.

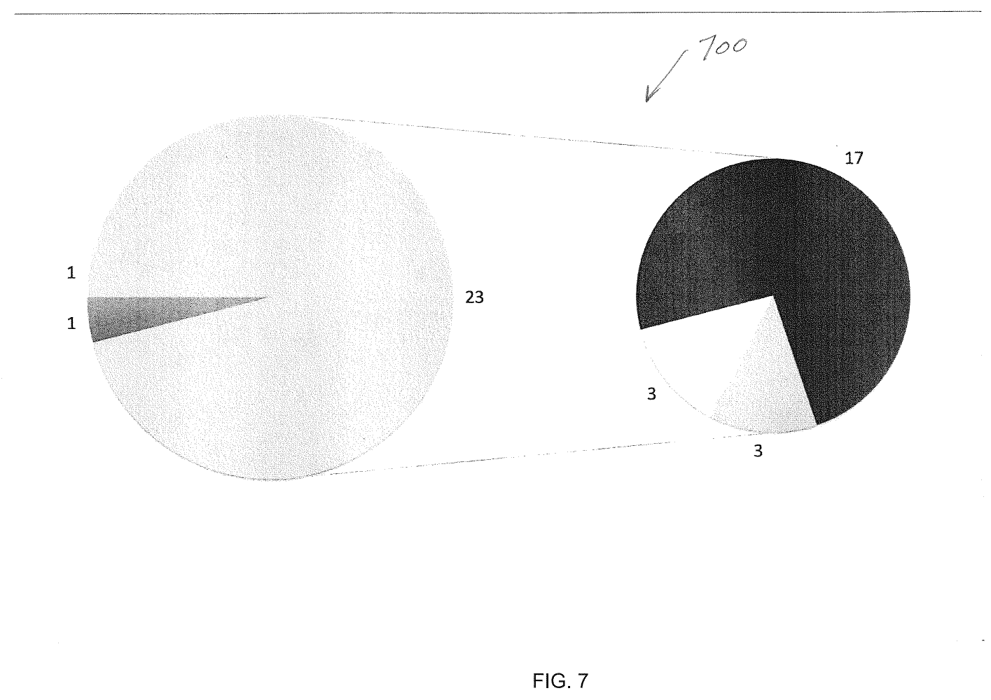

RQ2 focused on the balance between individual and automated actions. Each of Study 1 participants were asked who in their opinion contributed more to the music created: themselves and/or the system? 23 of 25 participants agreed with “The music created was due to a mixture of my and the system's contributions”; selecting this response prompted a follow-up question of “Who had more autonomy between you and the system?” FIG. 7 shows 17 of those 23 participants stated they had more autonomy than the system. Generally, participants who used the Luckyme and Random song(s) features attributed more autonomy to the system. One participant who responded with a “5: very creative” as to how they felt about their experience stated, “The software was a helping hand. I've thought about doing things like this before but this made it easier to come to life . . . I had more autonomy with the creative direction I was going for. (P5). Multiple participants stated that the randomizing features were creatively inspiring. However, some participants commented on how the randomization limited their creative expression.

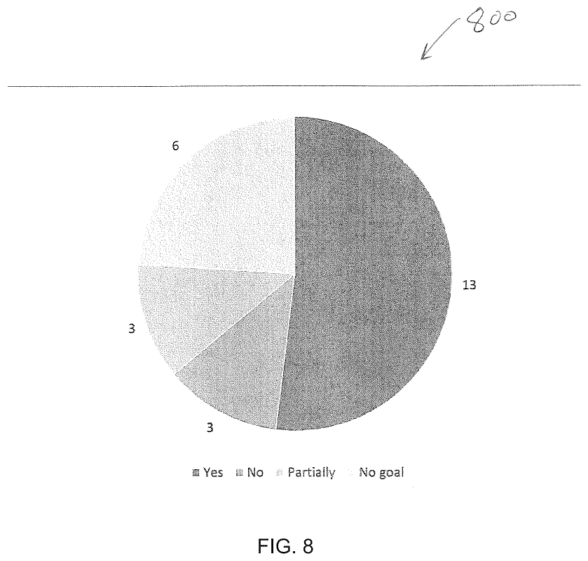

Previous experience and specific goals both influenced users to desire more control over the software. Eight (8) participants who shared that they had prior experience with audio or video editing software tended to expect and requested more control over their musical compositions. Participants who had specific mash-up ideas in mind tended to experience some limitations. FIG. 8 shows the responses from Study 1 participants when asked, “Were you able to accomplish what you were hoping to create?” Two (2) of the three (3) participants who stated their goals were not met both explained they had more ideas than what the time limit allowed for them.

The majority of participants selected songs that they knew, which typically led to exploring song pairings they thought would work well. When participants wanted specific segments, they struggled with knowing how to proceed. Twenty-six (26) of the forty-five (45) participants asked for control over the specific segments selected, which was the most requested feature. Furthermore, 11 of the 26 features requested would introduce further control to different aspects of the experience, such as controlling the tempo of the composition. While these requests are understandable, they are in contradiction to the original motivation of developing the audio mash-up app by limiting the amount of control the user can exert, the system also limits the amount of prior knowledge the user needs to create something enjoyable. Still, participants cited the lack of segment selection as a barrier to exploring their creativity. A participant who stated they felt neither creative nor not creative shared.” The option to choose the segments would've given me a lot more freedom.” (P31). This work designed and developed an audio mash-up application to creatively generate mash-ups that are musically coherent with the right level of control that is neither limited nor overwhelming. The app allows users to create mash-ups with up to 4 songs. The songs can be chosen either from a large library of songs from a server or from a commercial platform of audio files available for purchase or download.

The feature requests will be discussed amongst the development team to determine if they should be pursued. These notes will also be used to inform a user interface redesign. While there is a wealth of user feedback that would suggest the system should allow for greater user control, these works will strategically evaluate if pursuing control features would deviate from the app's original motivation and render the app to be more like a digital audio workstation (DAW).

Numerous features of the audio mash-up app are worth their own summary in terms of using artificial intelligence to enable the audio mash-up application. The AI informed back-end automatically splits the sources into corresponding stems and decides the right tempo, pitch and segments for the mash-up. A “Lucky Me” or “Surprise Me” feature provides intelligent layouts that can be modified by the user to taste. Users can co-creatively work with the AI system to explore their musical creativity without the knowledge of a DAW or waveform editing. The AI leverages tools from digital signal processing (DSP) and Music Information Retrieval (MIR) software as well as established music theory rules.

Embodiments of this disclosure may be configured as a system, a computer implemented method, and/or a computer program product.

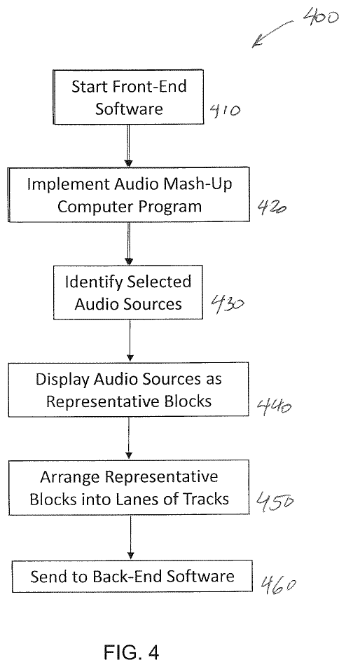

A system for combining audio tracks includes a first computer having a processor and computer memory storing front-end software 400 shown in FIG. 4 implementing an audio mash-up computer program. A remote computer includes a remote processor and remote computer memory implementing back-end software 500 corresponding to the audio mash-up computer program, wherein the computer and the remote computer communicate over a data communications network. A graphical user interface 100, 200, 300, on the first computer that is configured with the processor and audio mash-up computer program executes steps providing digital content on the graphical user interface for identifying a plurality of selected audio files 110A-110D, 210A-210D, 310A-310D as respective audio sources of audio segments to combine into an output audio file. The graphical user interface is configured for displaying the respective audio sources as representative blocks 120A-120G, 220A-220D, 320A-320F of source data and allows a user to engage in arranging the representative blocks into lanes 115A-115D, 215A-215D, 315 of respective audio tracks displayed on the graphical user interface. By combining the respective audio tracks into the output audio file according to an arrangement of the representative blocks as displayed in the lanes of respective audio tracks, the output audio file is configured for playing the respective audio tracks according to the arrangement displayed by the icons on the graphical user interface 105, 205, 305. Providing content on the graphical user interface includes displaying a data entry mechanism for selecting a total number of bars 353 as a length of the output audio file. Arranging the representative blocks includes providing a software tool to adjust individual bar lengths of the representative blocks of source data. The individual lengths of the representative blocks are adjustable from the graphical user interface according to a selected number of bars within the total number of bars 335 of the output audio file. The representative blocks can be stretched or shortened according to the bar lengths. In some implementations, the individual lengths of the representative blocks may be adjustable according to units of beats. The plurality of selected audio files may include at least two selected audio files. Other options include using different portions of a single audio file as audio sources. The plurality of selected audio files may include an example of four or more selected audio files. The plurality of selected audio files may be identified from a repository of files accessible by the first computer over the data communications network. The repository of files may include a library on the remote computer or a commercial platform connected to the network for providing the selected audio files and for providing the first computer with meta data regarding the plurality of selected audio files. The lanes of respective audio tracks can include a respective lane for a drum track, a vocals track, a bass track, or a chord track provided to the output audio file from at least one of the plurality of selected audio files. The chord track includes audio data that is distinct from the vocals track, the bass track, and the drum track (i.e., the chords lane includes segments that are not vocals, bass, or drums.). Combining the respective audio tracks into the output audio file includes transmitting, from the computer to the back-end software of the remote computer, a total number of bars 135, 235, 335 as a length of the output audio file; identifiers 310A, 310B, 310C for the plurality of selected audio files; the arrangement of the representative blocks in the lanes of audio track data; and individual bar lengths 133, 333 of the representative blocks. The arrangement of the representative blocks shows relative position data corresponding to relative positions of the representative blocks in the lanes of the audio track data, wherein the lanes of the audio track data comprise a drum track, a vocals track, a bass track, or a chord track. The placement of the representative blocks shows how a certain kind of track will be extracted from an audio source and played in conjunction with other kinds of tracks in the final mash-up audio output file. The arrangement of the representative blocks incorporates digital data corresponding to the total number of representative blocks and designations of start bars and stop bars at which the respective blocks provide audio data from a respective lane into the output audio file. The arrangement of the representative blocks includes at least one series of bars having overlapping positions relative to representative blocks in different lanes of the audio track data. The representative blocks include at least one series of bars having non-overlapping positions from representative blocks. The overlapping audio data comprises segments of the audio sources (i.e., the actual data corresponding to the representative blocks) output simultaneously from the output audio file as a mash-up output.

Combining the respective audio tracks into the output audio file may be accomplished by utilizing the back-end software 500 of the remote computer as shown in FIG. 5 to execute mash-up steps with the remote processor to receive, from the first computer, a total number of bars 135, 235, 335 as a length of the output audio file; identifiers 110A-110D, 210A—210D, 310A-310D for the plurality of selected audio files; relative position data corresponding to positions of the representative blocks 120A-120G, 220A-220D, 320A-320F in the lanes 115A-115D, 215A-215D, 315 of the audio track data, wherein the lanes of the audio track data comprise a drum track, a vocals track, a bass track, or a chord track; individual bar lengths of the representative blocks; and the total number of representative blocks and designations of start bars 130, 230, 330 at which the respective blocks provide positions for audio data from a respective lane into the output audio file. The back-end software of the remote computer also executes mash-up steps to retrieve the selected audio files from a repository connected to the data communications network; calculate an output tempo of the plurality of selected audio files; calculate an output pitch class of the plurality of selected audio files; separate the selected audio files into respective stems having a mix of recorded tracks and segmenting the stems into audio track segments corresponding to the lanes of the audio tracks displayed on the graphical user interface 105, 205, 305 of the first computer. The steps further include selecting the audio track segments to include in the audio output file; and rendering the audio output file by mixing selected audio track segments according to the arrangement of the representative blocks from the graphical user interface at the first computer. In optional embodiments, the back-end software further includes filtering out silent segments from the stems. For audio sources of music files, the stems are separated within the selected audio files according to identification as an introductory portion, a verse portion, a chorus portion, a bridge portion, or a coda portion of the audio file. In other embodiments, the respective stems are separated according to the back-end software identifying distinct sequences of audio data having a first bar and a last bar within the audio file. The respective stems are separated according to the back-end software identifying repetition of the distinct sequences of notes within the audio file and tracking the repeated sections as stand-alone units of audio sources. Segmenting the respective stems may include extracting respective segments of vocal content, bass content, drums content, and chords content from the respective stems and saving the respective segments in the memory of the remote computer. Using these segments, the back-end software identifies compatible segments from the respective stems for including in the output audio file, wherein identifying compatible segments may include comparing the respective segments from selected audio files according to key, bar length, tempo, or pitch. The back-end software identifies the compatible segments with a trained artificial intelligence computer program. The back-end software identifies the compatible segments with the trained artificial intelligence software comprising computerized steps based upon music structure analysis framework (MSAF). The back-end software calculates, from the compatible segments, a tempo ratio and a pitch ratio for the compatible segments. The back-end software also adjusts any individual segment for pitch and tempo according to relative tempo ratios and relative pitch ratios. The back end software calculates an output tempo and an output pitch for the compatible segments and applies the output tempo and the output pitch to the output audio file. The output tempo may be a mean of tempos of the compatible segments. Before taking a mean, the system may identify at least one outlier tempo within the compatible segments of audio data. The system can adjust that outlier tempo by doubling, halving or otherwise manipulating the tempo of a compatible segment to match, more closely, the tempo values of the other compatible segments. The back-end software is also configured to calculate the output pitch with the mashup software by converting the modes of the segments to relative minor and relative major and then averaging the pitches of the converted mode segments.

Ultimately, the system for combining audio files includes combining the compatible segments of the audio sources into the output audio file. The system may be configured to apply time-stretch and pitch-shift corrections to the output audio file for a more cohesive output sound. The back-end software transmits the output audio file from the remote computer to the first computer, unless the front-end software and the back-end software are running on a single computer. In any event, arranging the representative blocks into lanes of respective audio tracks may include retrieving a template from the back-end software for arranging the selected songs. The template may have been created by the back-end computer with artificial intelligence software utilizing a rules-based algorithm based on musical theory and composition. Combining the respective audio tracks comprises combining the audio tracks with the audio mash-up computer program on the first computer.

This disclosure includes a computer implemented method 400 shown in FIG. 4 of combining audio tracks having steps of using a computer to implement 410 a front end software program to run 420 an audio mash-up computer program therein and utilizing computer implemented instructions that execute the steps with a processor and identifying 430 a plurality of selected audio files as respective audio sources of audio segments to combine into an output audio file; displaying 440 the respective audio sources as representative blocks of source data; arranging 450 the representative blocks into lanes of respective audio tracks displayed on the graphical user interface; and after sending this data to a back-end software program 460, combining the respective audio tracks into the output audio file according to an arrangement of the representative blocks as displayed in the lanes of respective audio tracks, wherein the output audio file is configured for playing the respective audio tracks according to the arrangement. These steps may be included, at least in part in a front-end software program running an audio mashup computer program.

FIG. 5 shows a computer method 500 for running a back-end software operation 510, the method may include transmitting, from the computer to the back-end software of the remote computer a total number of bars as a length of the output audio file 550, identifiers for the plurality of selected audio files; the arrangement of the representative blocks in the lanes of audio track data at start bar locations 540; and individual bar lengths 530 of the representative blocks. The back-end software operation parses the data at 520. The back-end software of a remote computer executes mash-up steps to retrieve the selected audio files (gets song names 525) from a repository connected to the data communications network; calculate an output tempo 560 of the plurality of selected audio files; calculate an output pitch class 570 of the plurality of selected audio files; separate the selected audio files into respective stems having a mix of recorded tracks; and segmenting the stems into audio track segments 580 corresponding to the lanes of the audio tracks displayed on the graphical user interface of the first computer shown in FIGS. 1-3. The back-end software 500 may utilize artificial intelligence operating rules for selecting the audio track segments to include in the audio output file; and rendering the audio output file by mixing selected audio track segments according to the arrangement of the representative blocks from the graphical user interface at the first computer. The back end software is further configured to get tempo ratios 585, get pitch ratios 590, and get stem boundaries 592. Afterward, the back-end program is configured to time-stretch and pitch shift segments 593 as necessary for a desired output. Either the front end software or the back end software may be configured to import the final audio segments 594, overlay the stems 595, create the mashup and output the mashup 599.

All embodiments of this disclosure may be included in a computer program product stored on a non-transitory computer readable medium having computer implemented instructions that when executed by a processor execute a computerized method with steps including using a computer to run an audio mash-up computer program with computer implemented instructions that execute steps with a processor. The steps may include, without limitation, identifying a plurality of selected audio files as respective audio sources of audio segments to combine into an output audio file; displaying the respective audio sources as representative blocks of source data; arranging the representative blocks into lanes of respective audio tracks displayed on the graphical user interface; and combining the respective audio tracks into the output audio file according to an arrangement of the representative blocks as displayed in the lanes of respective audio tracks, wherein the output audio file is configured for playing the respective audio tracks according to the arrangement. The computerized method programmed into the computer program product further includes instructions for transmitting, from the computer to the back-end software of the remote computer a total number of bars as a length of the output audio file; identifiers for the plurality of selected audio files; the arrangement of the representative blocks in the lanes of audio track data; and individual bar lengths of the representative blocks. The computer program product further includes software for storing on a non-transitory computer readable medium with software instructions allowing the computer to implement a computerized method to retrieve the selected audio files from a repository connected to the data communications network; calculate an output tempo of the plurality of selected audio files; calculate an output pitch class of the plurality of selected audio files; separate the selected audio files into respective stems comprising a mix of recorded tracks; segmenting the stems into audio track segments corresponding to the lanes of the audio tracks displayed on the graphical user interface of the first computer; selecting the audio track segments to include in the audio output file; and rendering the audio output file by mixing selected audio track segments according to the arrangement of the representative blocks from the graphical user interface at the first computer. The computer program product includes appropriate instructions for arranging the representative blocks into lanes of respective audio tracks displayed on the graphical user interface, comprises arranging the blocks into lanes for vocal tracks, bass tracks, drum tracks, and chord tracks.

All aspects of the system embodiment are amenable to be described as computer implemented methods that may be incorporated into a computer program product.

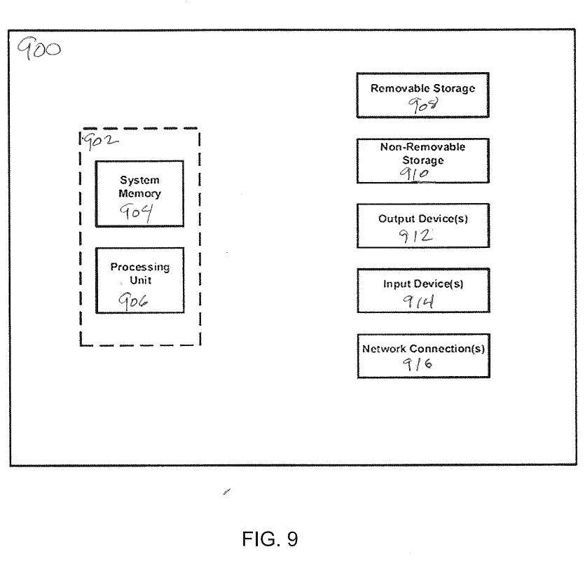

Referring to FIG. 9, an example computing device 900 upon which the methods described herein may be implemented is illustrated. It should be understood that the example computing device 900 is only one example of a suitable computing environment upon which the methods described herein may be implemented. Optionally, the computing device 900 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 900 typically includes at least one processing unit 906 and system memory 904. Depending on the exact configuration and type of computing device, system memory 904 may be volatile (such as random access memory (RAM)), non-volatile (such as read-only memory (ROM), flash memory, etc.), or some combination of the two. This most basic configuration is illustrated in FIG. 9 by dashed line 902. The processing unit 906 may be a standard programmable processor that performs arithmetic and logic operations necessary for the operation of the computing device 900. The computing device 900 may also include a bus or other communication mechanism for communicating information among various components of the computing device 900.

Computing device 900 may have additional features/functionality. For example, computing device 900 may include additional storage such as removable storage 908 and non-removable storage 910, including, but not limited to, magnetic or optical disks or tapes. Computing device 900 may also contain network connection(s) 916 that allow the device to communicate with other devices. Computing device 900 may also have input device(s) 914 such as a keyboard, mouse, touch screen, etc. Output device(s) 912, such as a display, speakers, printer, etc., may also be included. The additional devices may be connected to the bus in order to facilitate the communication of data among the components of the computing device 900. All these devices are well-known in the art and need not be discussed at length here.

The processing unit 906 may be configured to execute program code encoded in tangible, computer-readable media. Tangible, computer-readable media refers to any media that is capable of providing data that causes the computing device 900 (i.e., a machine) to operate in a particular fashion. Various computer-readable media may be utilized to provide instructions to the processing unit 906 for execution. Example of tangible, computer-readable media may include, but is not limited to, volatile media, non-volatile media, removable media, and non-removable media implemented in any method or technology for storage of information such as computer-readable instructions, data structures, program modules or other data. System memory 904, removable storage 908, and non-removable storage 910 are all examples of tangible, computer storage media. Examples of tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 906 may execute program code stored in the system memory 904. For example, the bus may carry data to the system memory 904, from which the processing unit 906 receives and executes instructions. The data received by the system memory 904 may optionally be stored on the removable storage 908 or the non-removable storage 910 before or after execution by the processing unit 906.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

Other machine learning and AI methods may be employed.

Machine Learning. In addition to the machine learning features described above, the system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by down sampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. While implementations will be described for steering wheel hand detection systems, it will become evident to those skilled in the art that the implementations are not limited thereto.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the sensing system for a steering wheel as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting or layering arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The embodiments of the method, system and computer program product described herein are further set forth in the claims below.

### REFERENCES

[1] M. E. P. Davies, P. Hamel, K. Yoshii, and M. Goto. AutoMash-upper: Automatic Creation of Multi-Song Music Mash-ups. IEEE/ACM Transactions on Audio, Speech, and Language Processing, 22(12): 1726-1737, December 2014. Conference Name: IEEE/ACM Transactions on Audio, Speech, and Language Processing.
[2] A. D'efossez. Hybrid spectrogram and waveform source separation. In Proceedings of the ISMIR 2021 Workshop on Music Source Separation, 2021.
[3] J. Grasso. Fuser. harmonix. windows pc, Nintendo switch, playstation 4, and xbox one. 2020. Journal of the Society for American Music, 16(3):357-358, 2022.
[4] G. Griffin, Y. E. Kim, and D. Turnbull. Beat-Sync-Mash-Coder: A web application for real-time creation of beat-synchronous music mash-ups. In 2010 IEEE International Conference on Acoustics, Speech and Signal Processing, pages 437-440, March 2010. ISSN: 2379-190X.
[5] M. Heydari, F. Cwitkowitz, and Z. Duan. Beatnet: Crnn and particle filtering for online joint beat downbeat and meter tracking. 2021.
[6] A. Joshi, S. Kale, S. Chandel, and D. K. Pal. Likert scale: Explored and explained. British journal of applied science & technology, 7(4):396, 2015.
[7] R. Louie, A. Coenen, C. Z. Huang, M. Terry, and C. J. Cai. Novice-AI Music Co-Creation via AI-Steering Tools for Deep Generative Models. In Proceedings of the 2020 CHI Conference on Human Factors in Computing Systems, pages 1-13, Honolulu HI USA, April 2020. ACM.
[8] C. Macas, A. Rodrigues, G. Bernardes, and P. Machado. Mixmash: a visualisation system for musical mash-up creation. In 2018 22nd International Conference Information Visualisation (IV), pages 471-477. IEEE, 2018.
[9] M. Marrington et al. Composing with the digital audio workstation. The singer-songwriter handbook, pages 77-89, 2017.
[10] S. Schechter, M. Krishnan, and M. D. Smith. Using path profiles to predict http requests. Computer Networks and ISDN Systems, 30(1-7):457-467, 1998.
[11] N. Tokui. Massh! a web-based collective music mash-up system. In Proceedings of the 3rd international conference on Digital Interactive Media in Entertainment and Arts, DIMEA '08, pages 526-527, New York, NY, USA, September 2008. Association for Computing Machinery.
[12] B. Xing, X. Zhang, K. Zhang, X. Wu, H. Zhang, J. Zheng, L. Zhang, and S. Sun. Popmash: an automatic musical-mash-up system using computation of musical and lyrical agreement for transitions. Multimedia Tools and Applications, 79(29):21841-21871, 2020.
[13] Elastique pro v3 by zplane. https://licensing.zplane.de/uploads/SDK/ELASTIQUE-PRO/V3/manual/elastique_pro_v3_sdk_documentation.pdf. Accessed: 2023-01-30.

1. A system for combining audio tracks, comprising:
a first computer comprising a processor and computer memory storing front-end software implementing an audio mash-up computer program;
a remote computer comprising a remote processor and remote computer memory implementing back-end software corresponding to the audio mash-up computer program, wherein the computer and the remote computer communicate over a data communications network;
a graphical user interface on the computer that is configured with the processor and audio mash-up computer program executing steps providing digital content on the graphical user interface for:
identifying a plurality of selected audio files as respective audio sources of audio segments to combine into an output audio file;
displaying the respective audio sources as representative blocks of source data;
arranging the representative blocks into lanes of respective audio tracks displayed on the graphical user interface; and
combining the respective audio tracks into the output audio file according to an arrangement of the representative blocks as displayed in the lanes of respective audio tracks, wherein the output audio file is configured for playing the respective audio tracks according to the arrangement.

2. (canceled)

3. The system of claim 1, wherein arranging the representative blocks comprises providing a software tool to adjust individual bar lengths of the representative blocks of source data.

4.-7. (canceled)

8. The system of claim 1, wherein the plurality of selected audio files is identified from a repository of files accessible by the first computer over the data communications network.

9. (canceled)

10. The system of claim 1, wherein the lanes of respective audio tracks comprise a respective lane for a drum track, a vocals track, a bass track, or a chord track provided to the output audio file from at least one of the plurality of selected audio files.

11. (canceled)

12. The system of claim 1, wherein combining the respective audio tracks into the output audio file comprises transmitting, from the computer to the back-end software of the remote computer:
a total number of bars as a length of the output audio file;
identifiers for the plurality of selected audio files;
the arrangement of the representative blocks in the lanes of audio track data; and
individual bar lengths of the representative blocks.

13. The system of claim 12, wherein the arrangement of the representative blocks comprises relative position data corresponding to relative positions of the representative blocks in the lanes of the audio track data, wherein the lanes of the audio track data comprise a drum track, a vocals track, a bass track, or a chord track.

14. The system of claim 13, wherein the arrangement of the representative blocks comprises digital data corresponding to the total number of blocks and designations of start bars and stop bars at which the respective blocks provide audio data from a respective lane into the output audio file.

15. The system of claim 14, wherein the arrangement of the representative blocks comprises at least one series of bars having overlapping positions relative to representative blocks in different lanes of the audio track data.

16. The system of claim 15, wherein the arrangement of the representative blocks comprises at least one series of bars having non-overlapping positions from representative blocks.

17. The system of claim 15, wherein the overlapping audio data comprises segments of the audio sources output simultaneously from the output audio file as a mash-up output.

18. The system of claim 15, wherein combining the respective audio tracks into the output audio file comprises utilizing the back-end software of the remote computer to execute mash-up steps with the remote processor to receive from the first computer:
a total number of bars as a length of the output audio file;
identifiers for the plurality of selected audio files;
relative position data corresponding to positions of the representative blocks in the lanes of the audio track data, wherein the lanes of the audio track data comprise a drum track, a vocals track, a bass track, or a chord track;
individual bar lengths of the representative blocks; and
the total number of representative blocks and designations of start bars at which the respective blocks provide positions for audio data from a respective lane into the output audio file.

19. The system of claim 18, further comprising utilizing the back-end software of the remote computer to execute mash-up steps to:
retrieve the selected audio files from a repository connected to the data communications network;
calculate an output tempo of the plurality of selected audio files;
calculate an output pitch class of the plurality of selected audio files;
separate the selected audio files into respective stems comprising a mix of recorded tracks; and
segmenting the stems into audio track segments corresponding to the lanes of the audio tracks displayed on the graphical user interface of the first computer;
selecting the audio track segments to include in the audio output file; and
rendering the audio output file by mixing selected audio track segments according to the arrangement of the representative blocks from the graphical user interface at the first computer.

20.-23. (canceled)

24. The system of claim 19, wherein segmenting the respective stems comprises extracting respective segments of vocal content, bass content, drums content, and chords content from the respective stems and saving the respective segments in the memory of the remote computer.

25. The system of claim 24, wherein the back-end software identifies compatible segments from the respective stems for including in the output audio file, wherein identifying compatible segments comprises comparing the respective segments from selected audio files according to key, bar length, tempo, or pitch.

26. (canceled)

27. The system of claim 25, wherein the back-end software identifies the compatible segments with the trained artificial intelligence software comprising computerized steps based upon music structure analysis framework (MSAF).

28. The system of claim 24, wherein the back-end software adjusts any individual segment for pitch and tempo according to relative tempo ratios and relative pitch ratios.

29. The system of claim 24, wherein the back end software calculates an output tempo and an output pitch for the compatible segments and applies the output tempo and the output pitch to the output audio file.

30. The system of claim 29, wherein the output tempo is a mean of tempos of the compatible segments.

31. The system of claim 30, further comprising adjusting at least one outlier tempo of the compatible segments.

32. The system of claim 29, wherein the back-end software calculates the output pitch with the mashup software by:
converting the modes of the segments to relative minor and relative major; and
averaging the pitches of the converted mode segments.

33. The system of claim 29, further comprising combining the compatible segments into the output audio file.

34. The system of claim 33, further comprising applying time-stretch and pitch-shift corrections to the output audio file.

35. The system of claim 34, further comprising transmitting the output audio file to the first computer.

36.-37. (canceled)

38. The system of claim 1, wherein combining the respective audio tracks comprises combining the audio tracks with the audio mash-up computer program on the first computer.

39. A computer implemented method of combining audio tracks, comprising:
using a computer to run an audio mash-up computer program comprising computer implemented instructions that execute the following steps with a processor:
identifying a plurality of selected audio files as respective audio sources of audio segments to combine into an output audio file;
displaying the respective audio sources as representative blocks of source data;
arranging the representative blocks into lanes of respective audio tracks displayed on the graphical user interface; and
combining the respective audio tracks into the output audio file according to an arrangement of the representative blocks as displayed in the lanes of respective audio tracks, wherein the output audio file is configured for playing the respective audio tracks according to the arrangement.

40. The computer implemented method of claim 39, further comprising:
transmitting, from the computer to the back-end software of the remote computer:
a total number of bars as a length of the output audio file;
identifiers for the plurality of selected audio files;
the arrangement of the representative blocks in the lanes of audio track data; and
individual bar lengths of the representative blocks.

41. The computer implemented method of claim 40, further comprising utilizing the back-end software of the remote computer to execute mash-up steps to:
retrieve the selected audio files from a repository connected to the data communications network;
calculate an output tempo of the plurality of selected audio files;
calculate an output pitch class of the plurality of selected audio files;
separate the selected audio files into respective stems comprising a mix of recorded tracks; and
segmenting the stems into audio track segments corresponding to the lanes of the audio tracks displayed on the graphical user interface of the first computer;
selecting the audio track segments to include in the audio output file; and
rendering the audio output file by mixing selected audio track segments according to the arrangement of the representative blocks from the graphical user interface at the first computer.

42.-45. (canceled)
